(19) United States
(12) Patent Application Publication
(10) Pub. No.: US 2018/0077864 A1
(43) Pub. Date: Mar. 22, 2018

(54) LOW PROFILE MOWER BLADES

(71) Applicant: MTD Products Inc, Valley City, OH (US)

(72) Inventors: Gerald Hobrath, Brunswick, OH (US); Amit Saha, Hudson, OH (US); Robert Jira, Middleburg Heights, OH (US)

(21) Appl. No.: 15/709,609

(22) Filed: Sep. 20, 2017

Related U.S. Application Data
(60) Provisional application No. 62/397,177, filed on Sep. 20, 2016.

(51) Int. Cl. A01D 34/73

(52) U.S. Cl. CPC A01D 34/733; A01D 34/64

(57) ABSTRACT

A mower blade for a lawn maintenance device includes an elongate blade having opposed end edges and opposed side edges. The elongate blade is adapted for mounting onto a rotary mower for rotation about a center axis extended transverse to the elongate blade and separating the elongate blade into opposed elongate end portions extended from said center axis. The elongate blade has a blade major axis and defines a curved portion such that the curved portion is opposite a cutting edge. The curved portion extends from the elongate blade in an upward direction where the two meet and curves toward a lower face of the elongate blade. Further examples of the mower blade include the curved portion being offset vertically from a cutting edge to develop lift during rotation and a constant cross-section over most of the blade major axis.

### CROSS-REFERENCE TO RELATED APPLICATIONS

This application claims priority to U.S. Provisional Patent Application Ser. No. 62/397,177, filed Sep. 20, 2016 titled LOW PROFILE MOWER BLADES and U.S. Design patent application Ser. No. 29/578,374, filed Sep. 21, 2016, and titled CUTTING BLADE which are herein incorporated by reference in their entireties.

### BACKGROUND

### 1. Field of the Disclosure

The present disclosure relates to lawn and garden equipment, and more particularly, to a low-profile cutting blade for a mower.

### 2. Description of Related Art

Currently available lawn mowers such as walk-behind mowers, riding mowers, garden tractors, and the like include a cutting deck having at least one cutting blade configured to cut grass and other vegetation. When using a blade with a bagging attachment, the blade often includes an inclined surface to create lift under the deck to stand the grass upright and provide an airstream to move grass clippings into the bagging attachment. However, usage of this type of blade in situations involving soils containing a relatively high sand content can erode the inclined surface portion of the cutting blade. After time, the inclined surface may be entirely removed, thereby eliminating certain functionality of the blade. This can require relatively frequent blade replacement.

Therefore, a need exists for a mower blade having a low-lift air flow such that some airstream is provided while reducing the wear of sand impingement upon the blade.

### BRIEF SUMMARY

According to one aspect of the present disclosure, a mower blade for a lawn maintenance device includes an elongate blade having opposed end edges and opposed side edges. The elongate blade is adapted for mounting onto a rotary mower for rotation about a center axis extended transverse to the elongate blade and separating the elongate blade into opposed elongate end portions extended from said center axis. The elongate blade has a blade major axis. The elongate blade defines a curved portion such that the curved portion is opposite a cutting edge. The curved portion extends from the elongate blade in an upward direction where the two meet and curves toward a lower face of the elongate blade.

According to another aspect of the present disclosure, a mower blade for a lawn maintenance device includes an elongate blade having opposed end edges and opposed side edges. The elongate blade is adapted for mounting onto a rotary mower for rotation about a center axis extended transverse to the elongate blade and separating the elongate blade into opposed elongate end portions extended from the center axis. The elongate blade has a blade major axis. The elongate blade defines a curved portion such that the curved portion is opposite a cutting edge. The curved portion extends from the elongate blade in an upward direction where the two meet and curves toward a lower face of the elongate blade. A distal portion of the curved portion is offset vertically from a cutting edge to develop lift during rotation.

According to still another aspect of the present disclosure, a mower blade for a lawn maintenance device includes an elongate blade having opposed end edges and opposed side edges. The elongate blade is adapted for mounting onto a rotary mower for rotation about a center axis extended transverse to the elongate blade and separating the elongate blade into opposed elongate end portions extended from the center axis. The elongate blade has a blade major axis. The elongate blade defines a curved portion such that the curved portion is opposite a cutting edge. The curved portion extends from the elongate blade in an upward direction where the two meet and curves toward a lower face of the elongate blade. The curved portion has a constant cross-section over most of the blade major axis.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1 is an isometric view of an exemplary low profile mower blade according to at least one embodiment of the present disclosure;

FIG. 2 is an elevation view of the low profile mower blade of FIG. 1;

FIG. 3 is a top view of the low profile mower blade of FIG. 1;

FIG. 4 is a cross-section view taken along line 4-4 of FIG. 1;

FIG. 5 is a cross-section view taken along line 5-5 of FIG. 1; and

FIG. 6 is an isometric view of a low profile mower blade showing an alternative mounting arrangement.

It should be noted that all the drawings are diagrammatic and not drawn to scale. Relative dimensions and proportions of parts of these figures have been shown exaggerated or reduced in size for the sake of clarity and convenience in the drawings. The same reference numbers are generally used to refer to corresponding or similar features in the different embodiments. Accordingly, the drawing(s) and description are to be regarded as illustrative in nature and not as restrictive.

### DETAILED DESCRIPTION

Example embodiments that incorporate one or more aspects of the present disclosure are described and illustrated in the drawings. These illustrated examples are not intended to be a limitation on the present disclosure. For example, one or more aspects of the present disclosure can be utilized in other embodiments and even other types of devices. Moreover, certain terminology is used herein for convenience only and is not to be taken as a limitation on the present disclosure. Still further, in the drawings, the same reference numerals are employed for designating the same elements.

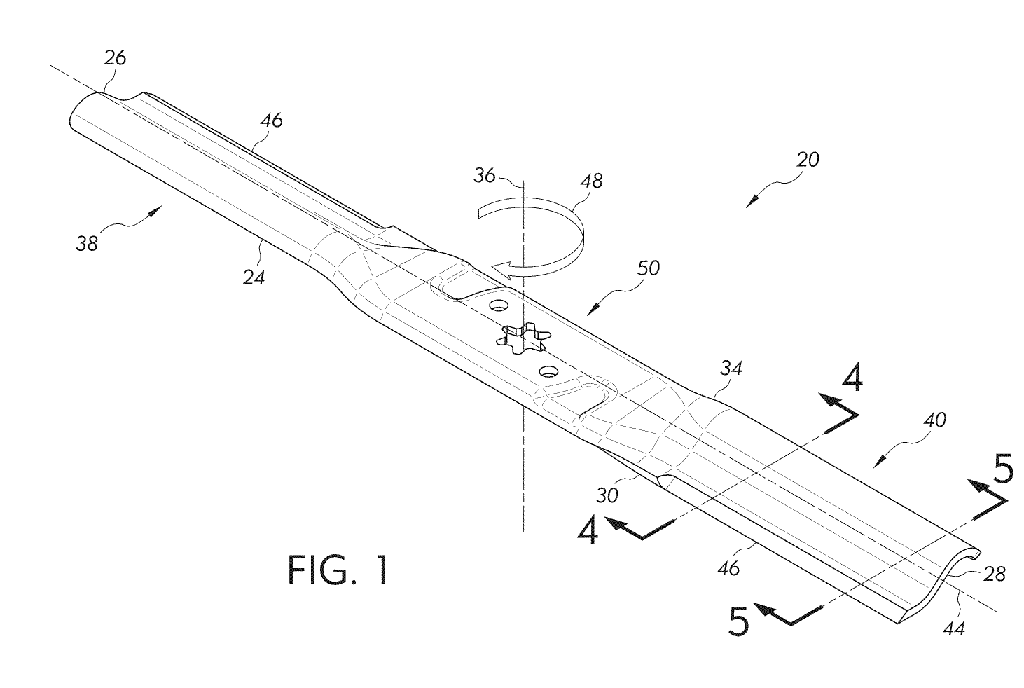

Turning to FIG. 1, an isometric view of an exemplary low profile mower blade 20 is shown. The low profile mower blade 20 includes an elongate blade 24 having a first end edge 26 and a second end edge 28 that are opposed to one another. A first side edge 30 and a second side edge 34 are also opposed to one another, and together, the first end edge 26, the second end edge 28, the first side edge 30, and the second side edge 34 generally form the four sides of the low profile mower blade 20.

The low profile mower blade 20 is adapted for mounting onto a lawn maintenance device (e.g., a rotary mower) (not shown) for rotation about a center axis 36 extended transverse to the elongate blade 24. The center axis 36 separates the elongate blade 24 into opposed elongate end portions 38, 40 extending from the center axis 36. The elongate blade 24 also includes a blade major axis 44.

In one example, the elongate blade 24 can be configured with a pair of sharpened cutting edges 46. The sharpened cutting edges 46 are located on the first and second side edges 30, 34 such that when the low profile mower blade 20 rotates in the direction shown by arrow 48, the sharpened cutting edges 46 are each on a leading edge of the elongate blade 24 to cut grass and/or vegetation. In one example, the sharpened cutting edges 46 can be two inches to six inches in length.

The central portion 50 of the low profile mower blade 20 can include structure for mounting the low profile mower blade 20 to a rotating shaft, such as a spindle, engine shaft, etc. such that the low profile mower blade 20 can be rotated by a power source on a rotary mower (not shown). The power source can be any suitable power source including, but not limited to, a gasoline powered engine, a corded electric motor, a battery-powered electric motor, etc. Similarly, the low profile mower blade 20 can define one or more apertures to cooperate with physical features located on the rotary mower to attach the low profile mower blade 20 to structure on the rotary mower. Any suitable attachment structure or definition is contemplated with the present disclosure.

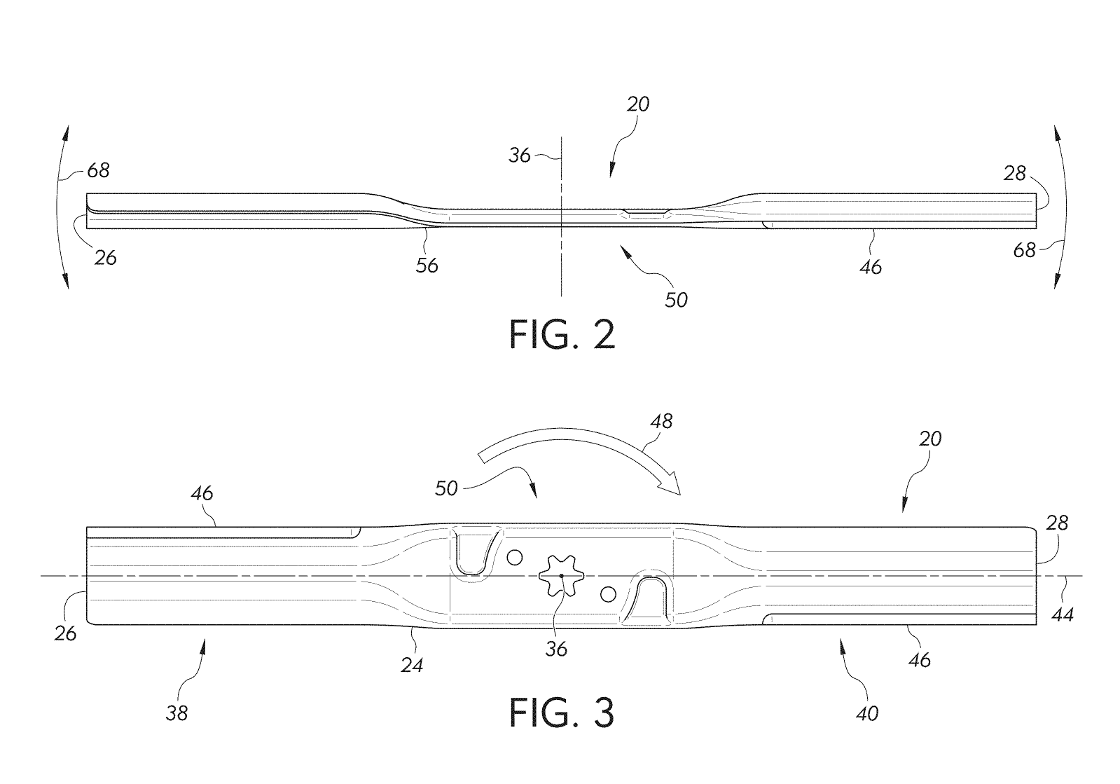

Turning to FIG. 2, the exemplary low profile mower blade 20 is shown in an elevation view. As seen in the figure, one sharpened cutting edge 46 is shown on the lower right side of the low profile mower blade 20.

Many cutting blades and mower blades incorporate a ramped surface or sail opposite the sharpened cutting edge 46 in order to produce lower air pressure above and higher air pressure below the rotating cutting blade so as to effectively create lift of the grass, other vegetation, and subsequent clippings. This lift can be used to straighten the grass and vegetation prior to cutting and provide a force to move the clippings to a collection bag or out a discharge chute (not shown). However, in particular situations such as cutting grass and/or vegetation in a location that contains a relatively high percentage of sand within the soil, the ramped surface or sail is constantly experiencing an impingement of sand particles along the length of the ramped surface. This, in turn, effectively sandblasts or wears away the ramped surface within a relatively short time.

Turning to FIG. 3, a top view of the low profile mower blade 20 is shown. As previously described, the low profile mower blade includes the elongate blade 24 having end portions 38, 40 extending from the center axis (represented by a dot at 36). The elongate blade 24 also includes a blade major axis 44 and is configured with a pair of sharpened cutting edges 46. The sharpened cutting edges 46 are located on the first and second side edges 30, 34 such that when the low profile mower blade 20 rotates in the direction shown by arrow 48, the sharpened cutting edges 46 are each on a leading edge of the elongate blade 24 to cut grass and/or vegetation.

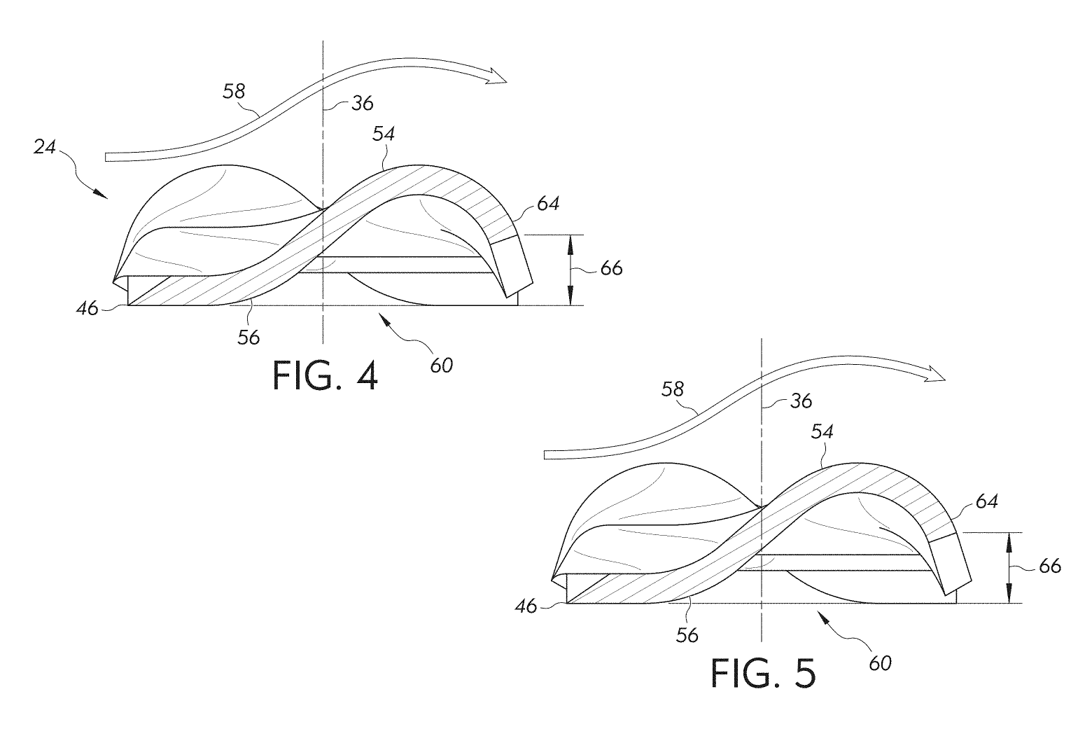

Turning to FIG. 4, a cross-section view of the elongate blade 24 is shown. Rather than including a sail or ramped surface opposite the cutting edge, the elongate blade 24 defines a curved portion 54 such that the curved portion 54 is opposite the sharpened cutting edge 46. As shown, the curved portion 54 extends from the elongate blade 24 in an upward direction from where the sharpened cutting edge 46 and the curved portion 54. In this example, the term “upward direction” is used to define the direction that is perpendicular to a driven surface (e.g., the turf) that is generally considered “up,” as the lawn maintenance device is normally operated. The curved portion 54 then curves to point downward toward a lower face 56 of the elongate blade 24. The curved portion 54 provides significantly less air turbulence as the low profile mower blade 20 revolves around the center axis 36. This reduction in air turbulence encourages objects (e.g., grains of sand) to flow over and behind the rotating low profile mower blade 20 rather than striking a portion of the low profile mower blade 20 such as a sail or ramped portion and subsequently destroying the sail or ramped portion. The airflow pattern is generally represented by arrow 58 in FIG. 4.

The curved portion 54 defines a concave space 60 on the lower face 56 of the elongate blade 24. The concave space 60 also encourages the development of a lower air pressure above the grass and/or vegetation in order to urge the grass and/or vegetation to an upright position for cutting by the rotating low profile mower blade 20.

In at least one example of the low profile mower blade 20, the curved portion 54 of the elongate blade 24 includes a distal portion 64 is offset vertically from the sharpened cutting edge 46. As shown in FIG. 3, the distal portion 64 offset from the sharpened cutting edge 46 is measured along a line that is generally parallel to the center axis 36. In a specific example, the distal portion 64 of the curved portion 54 is higher in elevation from the driven surface (e.g., the turf) than the sharpened cutting edge 46. This offset distance is represented by dimension 66. Similar to the geometry of the curved portion 54, the offset distance 66 helps develop lift during rotation of the low profile mower blade 20. In one example, the offset distance 66 is less than about one-half inch (1.27 cm) higher in elevation than the sharpened cutting edge 46. In another example, the offset distance 66 is greater than about one-quarter inch (0.6 cm) higher in elevation than said sharpened cutting edge 46.

Turning to FIG. 5, another cross-section view of the elongate blade 24 is shown. FIGS. 4 and 5 are identical apart from the reference numerals. The comparison is useful to show that over most of the blade major axis 44, the elongate blade 24 has a constant cross-section. This can be of particular use when scaling the low profile mower blade 20 to different mower applications. For example, if a walk-behind mower requires a 30-inch long blade, and there is a 28-inch long blade already designed, the designer can merely add another inch to each of the end portions 38, 40 to create the 30-inch long blade. Similarly, to design a low profile mower blade 20 with a shorter length, a designer merely removes a desired length from each of the end portions 38, 40. This can save design and engineering time, and thus cost.

It is also worthy of note that the curved portion 54 develops flexion stability between the central portion 50 and the end portions 38, 40 of the low profile mower blade. In many relatively flat mower blades, a flat piece of metal stock is sharpened on either side to function as a mower blade. However, these known flat blades often lack a flexion stability and can flex according to arrows 68 in FIG. 2. As can be appreciated, this type of flexion can create undesired variability in grass cutting height and results in a rough grass cut that is often undesirable. As such, the added stiffness provided by the curved portion 54 to the elongate blade 24 can be beneficial.

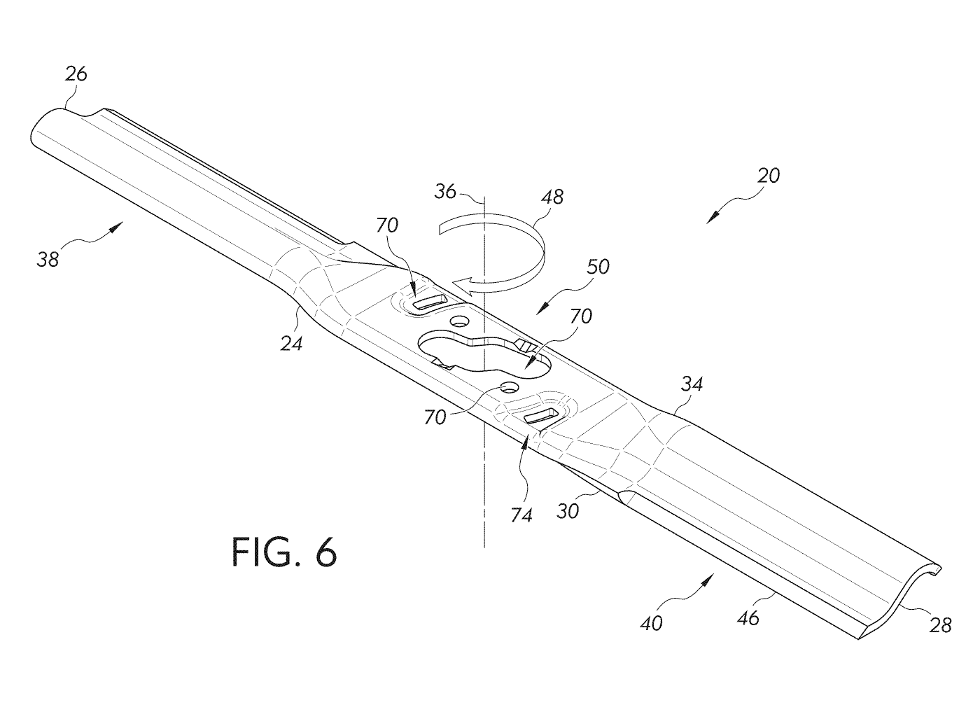

Turning to FIG. 6, an alternate mounting structure is shown. As previously mentioned, any suitable mounting structure or definition can be used with the low profile mower blade 20 of the present disclosure. As an example, FIG. 6 shows apertures 70 and embossed areas 74 suitable for use with a quick-change attachment scheme as described in U.S. patent application Ser. No. 14/847,909 and its family members.

The apparatus of the present disclosure can have several benefits. The low profile mower blade can increase the lifespan of the mower blade when used over soils or surfaces having a relatively high sand content. In some examples, the low profile mower blade can last as much as four times as long as a typical lawn mower blade having a sail or ramped surface to develop lift. In other examples, the blade can last three times as long as a typical lawn mower blade. Additionally, the low profile mower blade can present a greater surface area upon which to deflect objects such as grains of sand in comparison to typical sail-employing mower blades. The greater surface area not withstanding, the low profile mower blade also can eliminate a significant amount of blade wear caused by object impingement simply by having the low profile. This lower profile can also significantly reduce the drag forces operating on the low profile mower blade. In some cases, the drag can be reduced by as much as 12.5% in comparison to a standard mower blade.

Other benefits can include a constant cross-section profile that is easily scalable to other mower applications (e.g., longer or shorter blade lengths). The described low profile mower blade can also provide flexion stability or stiffness along the blade major axis to reduce and/or eliminate rough cuts due to the mower blade ends moving up and down relative to the center portion during operation.

While this disclosure has been written in conjunction with the specific embodiments described above, it is evident that many alternatives, combinations, modifications and variations are apparent to those skilled in the art. Accordingly, the described embodiments of this disclosure, as set forth above are intended to be illustrative only, and not in a limiting sense. Various changes can be made without departing from the spirit and scope of this disclosure. Combinations of the above embodiments and other embodiments will be apparent to those of skill in the art upon studying the above description and are intended to be embraced therein. Therefore, the scope of the present disclosure is defined by the appended claims, and all devices, processes, and methods that come within the meaning of the claims, either literally or by equivalence, are intended to be embraced therein. Furthermore, to the extent that the term “includes” is used in either the detailed description or the claims, such term is intended to be inclusive in a manner similar to the term “comprising” as “comprising” is interpreted when employed as a transitional word in a claim.

1. A mower blade for a lawn maintenance device comprising:
an elongate blade having opposed end edges and opposed side edges, said elongate blade is adapted for mounting onto a rotary mower for rotation about a center axis extended transverse to the elongate blade and separating said elongate blade into opposed elongate end portions extended from said center axis, said elongate blade having a blade major axis, wherein
said elongate blade defines a curved portion such that said curved portion is opposite a cutting edge, and
said curved portion extends from said elongate blade in an upward direction where the two meet and curves toward a lower face of said elongate blade.

2. The mower blade according to claim 1, wherein said curved portion defines a concave space on said lower face of said elongate blade.

3. A mower blade for a lawn maintenance device comprising:
an elongate blade having opposed end edges and opposed side edges, said elongate blade is adapted for mounting onto a rotary mower for rotation about a center axis extended transverse to the elongate blade and separating the elongate blade into opposed elongate end portions extended from said center axis, said elongate blade having a blade major axis, wherein
said elongate blade defines a curved portion such that said curved portion is opposite a cutting edge,
said curved portion extends from said elongate blade in an upward direction where the two meet and curves toward a lower face of said elongate blade, and
a distal portion of said curved portion is offset vertically from a cutting edge to develop lift during rotation.

4. The mower blade according to claim 3, further comprising a sharpened cutting edge.

5. The mower blade according to claim 4, wherein said distal portion of said curved portion is higher in elevation than said sharpened cutting edge.

6. The mower blade according to claim 5, wherein said distal portion of said curved portion is less than about one-half inch (1.27 cm) higher in elevation than said sharpened cutting edge.

7. The mower blade according to claim 5, wherein said distal portion of said curved portion is greater than about one-quarter inch (0.6 cm) higher in elevation than said sharpened cutting edge.

8. A mower blade for a lawn maintenance device comprising:
an elongate blade having opposed end edges and opposed side edges, said elongate blade is adapted for mounting onto a rotary mower for rotation about a center axis extended transverse to the elongate blade and separating the elongate blade into opposed elongate end portions extended from said center axis, said elongate blade having a blade major axis, wherein
said elongate blade defines a curved portion such that said curved portion is opposite a cutting edge,
said curved portion extends from said elongate blade in an upward direction where the two meet and curves toward a lower face of said elongate blade, and
said curved portion has a constant cross-section over most of said blade major axis.
